(19) United States
(12) Patent Application Publication
(10) Pub. No.: US 2014/0240320 A1
(43) Pub. Date: Aug. 28, 2014

(54) Smart Timelines

(71) Applicants: Eddy Malik, Redmond, WA (US); Tim Stumbles, Carnation, WA (US); Andrei Cojocaru, Iasi (RO); Dumitru-Bogdan Sireteanu, Iasi (RO); Dan Vasilov, Iasi (RO); Ana Valentina Bigu, Iasi (RO); Scheul Florentina, Iasi (RO); Roxana Lujinschi, Iasi (RO)

(72) Inventors: Eddy Malik, Redmond, WA (US); Tim Stumbles, Carnation, WA (US); Andrei Cojocaru, Iasi (RO); Dumitru-Bogdan Sireteanu, Iasi (RO); Dan Vasilov, Iasi (RO); Ana Valentina Bigu, Iasi (RO); Scheul Florentina, Iasi (RO); Roxana Lujinschi, Iasi (RO)

(21) Appl. No.: 14/172,900

(22) Filed: Feb. 4, 2014

Related U.S. Application Data
(60) Provisional application No. 61/760,566, filed on Feb. 4, 2013.

(51) Int. Cl. G06T 11/20

(52) U.S. Cl. CPC G06T 11/206
USPC 345/440

(57) ABSTRACT

The instant application discloses, among other things, techniques to automatically generate a timeline layout in office presentation software that is easy to read and visually appealing while exposing all the desired information.

### FIELD

This disclosure relates to techniques of creating timelines.

### BACKGROUND

Several tools are available to draw charts, such as timelines and Gantt charts, for projects. Typically, attributes for various aspects of the elements on these charts must be manually selected and laid out. When content-dense, as in the case with many milestones for a project, it can be challenging to obtain a clear, readable layout.

### SUMMARY

The instant application discloses, among other things, techniques to allow a layout that is easy to read and visually appealing while exposing all the desired information.

For example, there are often periods of dense milestones during a project. A layout clearly displaying selected information about milestones may be automatically generated, recognizing issues related to limited space next to neighboring milestones.

Various designs may be used. In one embodiment, pointer flags stacked vertically may be sufficient to display the data. In another embodiment, callout lines may be angled to provide more options for locations of text.

In yet another embodiment, text may be grouped in bands, and the bands may be used to provide readable layouts, even for time ranges with several milestones.

### BRIEF DESCRIPTION OF THE DRAWINGS

FIG. 1 is an example of a system capable of supporting Smart Timelines.

FIG. 2 is an illustration showing an example of a Smart Timeline according to one embodiment.

FIG. 3 illustrates an example of a Smart Timeline with a single milestone displayed, according to one embodiment.

FIG. 4 illustrates an example of a Smart Timeline with two milestones displayed, according to one embodiment.

FIG. 5 illustrates an example of a Smart Timeline with three milestones displayed, according to one embodiment.

FIG. 6 illustrates an example of a Smart Timeline with four milestones displayed, according to one embodiment.

FIG. 7 is a flowchart for laying out milestone descriptions according to one embodiment.

FIG. 8 illustrates a component diagram of a computing device according to one embodiment.

### DETAILED DESCRIPTION

A more particular description of certain embodiments of Smart Timelines may be had by references to the embodiments shown in the drawings that form a part of this specification, in which like numerals represent like objects.

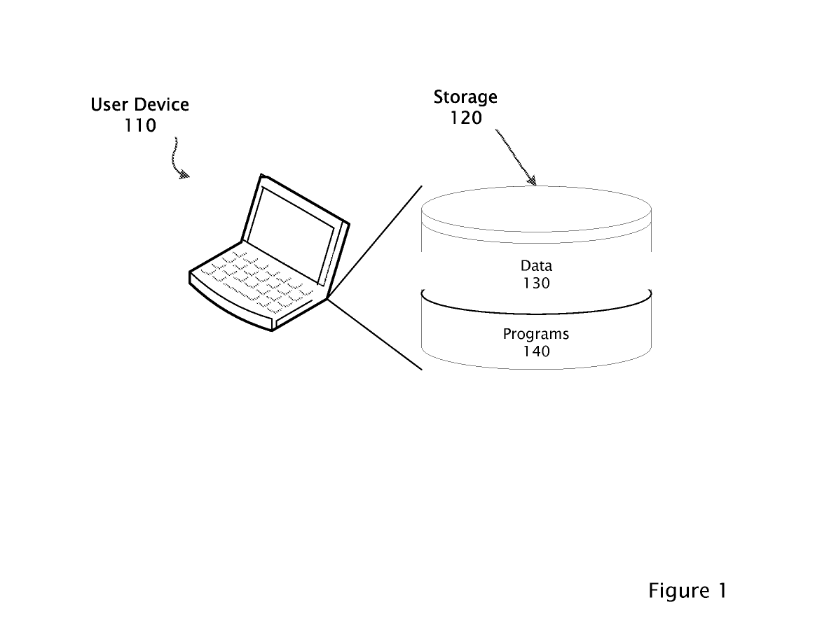

FIG. 1 is an example of a system capable of supporting Smart Timelines. User Device 110 may include a processor, memory and computer readable storage media capable of holding Programs 140 and Data 130.

Data 130 may include data related to a project, including milestones, tasks, resources required, start and end dates, descriptions, and other project metadata. Programs 140 may include business graphics applications such as Microsoft Powerpoint®, other applications, and one or more applications supporting Smart Timelines. Smart Timelines may be implemented as an add-in to an application, a standalone application, or a website, but it is not limited to these embodiments.

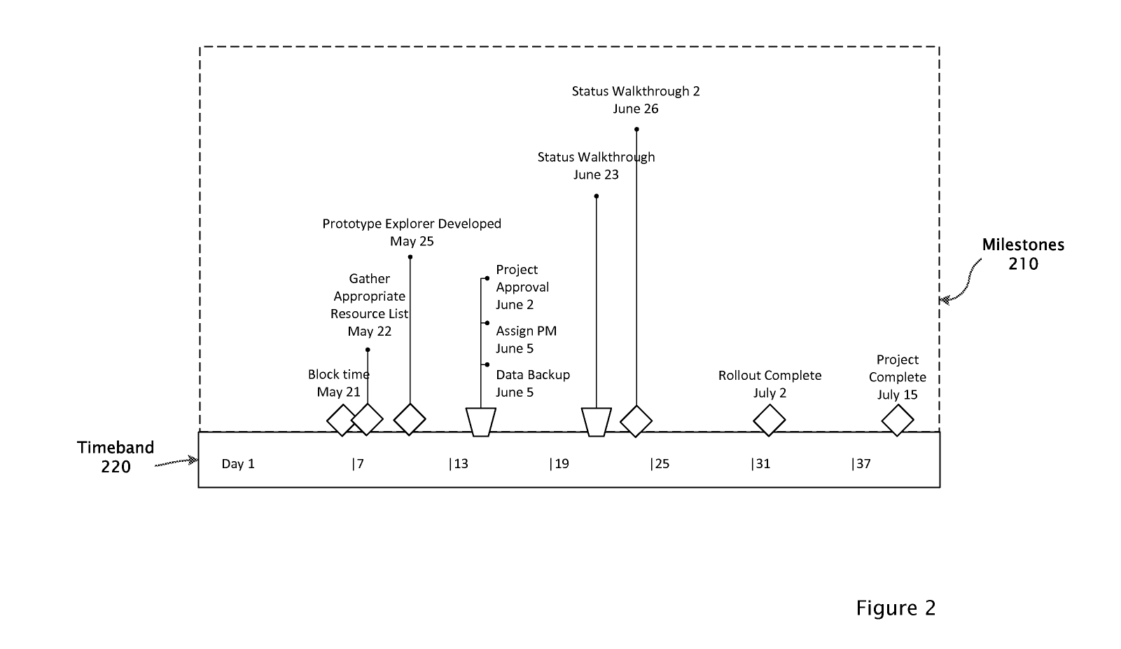

FIG. 2 is an illustration showing an example of a Smart Timeline according to one embodiment. In this embodiment, a user may have entered attributes describing each of Milestones 210 near Timeband 220. Milestones 210 may be displayed above, below, or both above and below Timeband 220.

Attributes for Milestones 210 may include a start date, an end date, a type, a description, resources, status, priority, costs, display attributes such as font type and size, color, marker type, or other associated information or data.

When Milestones 210 are placed near Timeband 220, Smart Timelines may display attributes in an aesthetically pleasing and functional layout, so that information is readable and understandable. This may result in flags placed at angles, the use of different colors, various line lengths, and other display attributes to differentiate, group, highlight, minimize, or in other ways indicate specific Milestones 210.

Smart Timelines may sense neighboring text and objects and may automatically place objects to prevent overlapping.

Display colors may be automatically assigned depending on a type of Milestone or Task 210, or may be automatically assigned based on a status. Other attributes may also result in the automatic assignment of display colors.

Keywords found in Milestones 210 may be assigned to preset styles, so that, for example, a Milestone 210 associated with the word “Kickoff” may be displayed in green. Other keywords may be associated with other styles, and styles may include marker shape, color, information to be displayed, or other display attributes.

Smart Timelines may also determine which markers to place above and which markers to place below Timeband 220. This may depend on ownership, status, type of Milestone 210, or other attributes. Smart Timelines may also determine size and shape of markers to use for each Milestone or Task 210. Date format may also be determined automatically, so that, for example, if a project is spread out over several years, displayed dates may include year information, while a shorter project may just need month and day.

In another embodiment, Smart Timelines may adjust the height or width of a Timeband 220 and the spacing of Milestones 210 based on dates or times or other attributes.

In yet another embodiment, Smart Timelines may adjust spacing, locations, colors, or other attributes based upon a display's capabilities, including resolution, color depths, pixel sizes, or other attributes of the display. In one embodiment, spacing may be based on a percentage of a screen resolution. In another embodiment, sizes may have specific sizes.

One having skill in the art will recognize that many different attributes may trigger many different formatting and layout choices for an automatic arrangement. Colors, shapes, sizes, information, length of timeline, and any other display attributes may be adjusted automatically.

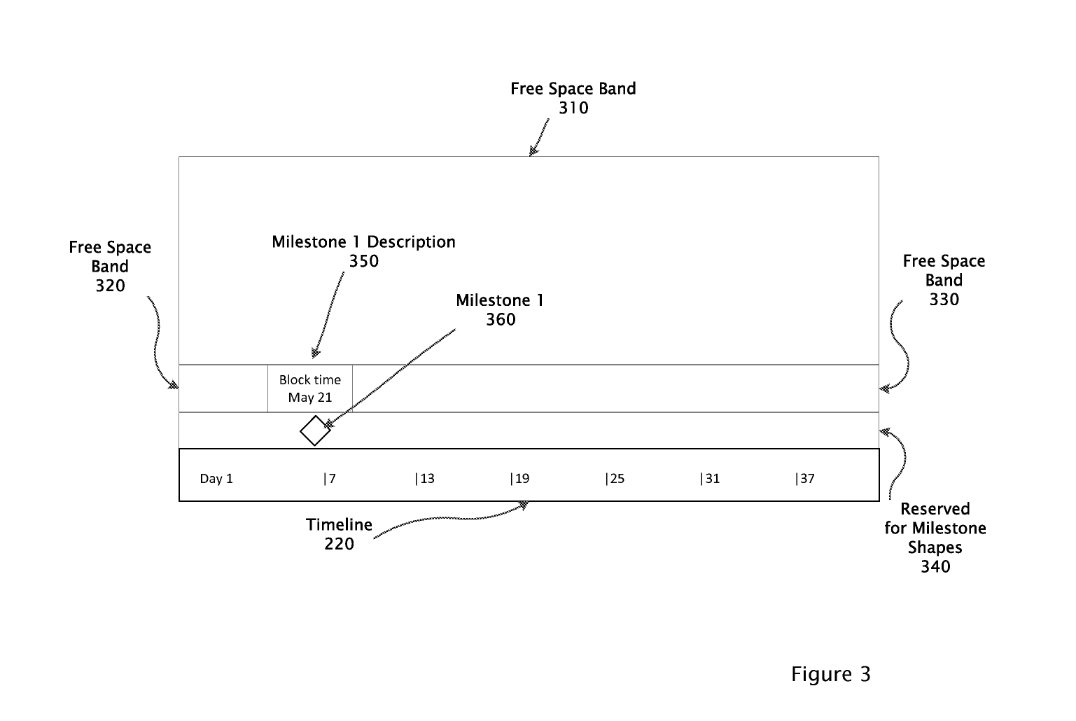

FIGS. 3 to 6 illustrate a way to layout milestone descriptions in a readable and aesthetically pleasing Smart Timeline, according to one embodiment.

FIG. 3 illustrates an example of a Smart TimeLine with a first milestone displayed, according to one embodiment. Milestone 1 Description 350 may be located above Milestone 1 360, and a height may be calculated based upon a bounding box for contents of Milestone 1 Description to determine a band of space. That band may be divided into Free Space Bands 320 and 330, separated by Milestone 1 Description 350. A remainder of space on the Smart Timeline above Free Space Bands 320 and 330 and Milestone 1 Description 350 may be considered Free Space Band 310. When additional milestones are added, banding may be used to determine a layout.

In the following figures, as each milestone is added, a bounding box may be created based on the contents of the description of the milestone. The first milestone may be placed closest to Timeband 220 and an appropriate date location on the timeline.

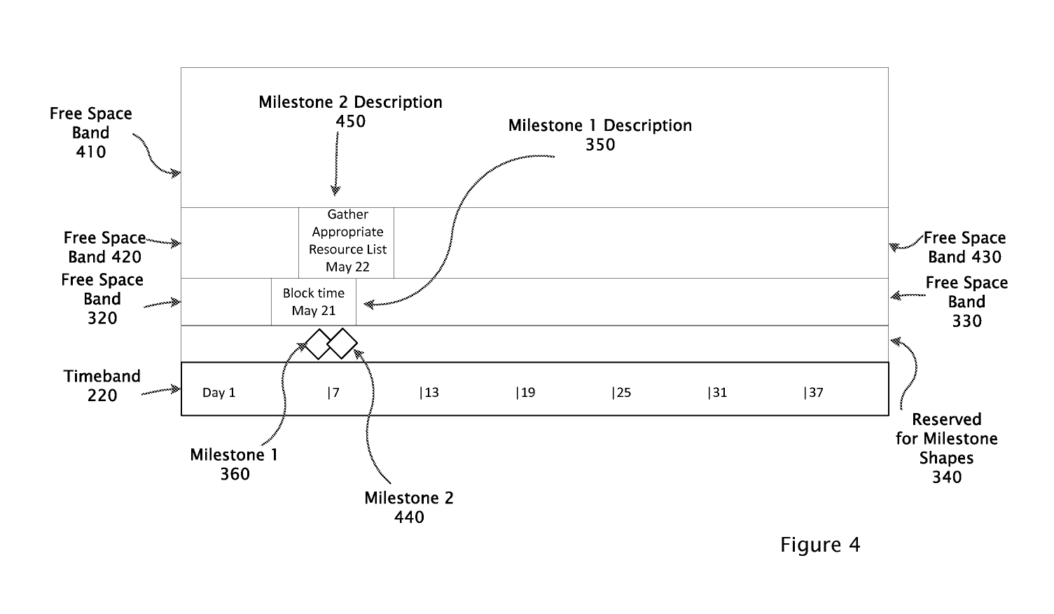

FIG. 4 illustrates an example of a Smart Timeline with a second milestone, Milestone 2 440, displayed, according to one embodiment. A second milestone, Milestone 2 440, has been added to the Smart Timeline shown in FIG. 3. A bounding box may be determines for Milestone 2 Description 450, and a test may be made to determine if Milestone 2 Description 450 will fit in Free Space Band 310. If not, as in this example, Milestone 2 Description 450 may be placed in a second band created above the existing Free Space Bands 320, 330, in space previously contained in Free Space Band 310. The height of this second band may be determined based upon a bounding box for Milestone 2 Description 450. Similar to the band for Milestone 1 Description 350, the second band may be divided into Free Space Band 420 and Free Space Band 430. Free Space Band 410 may allow for further growth upward for additional milestones.

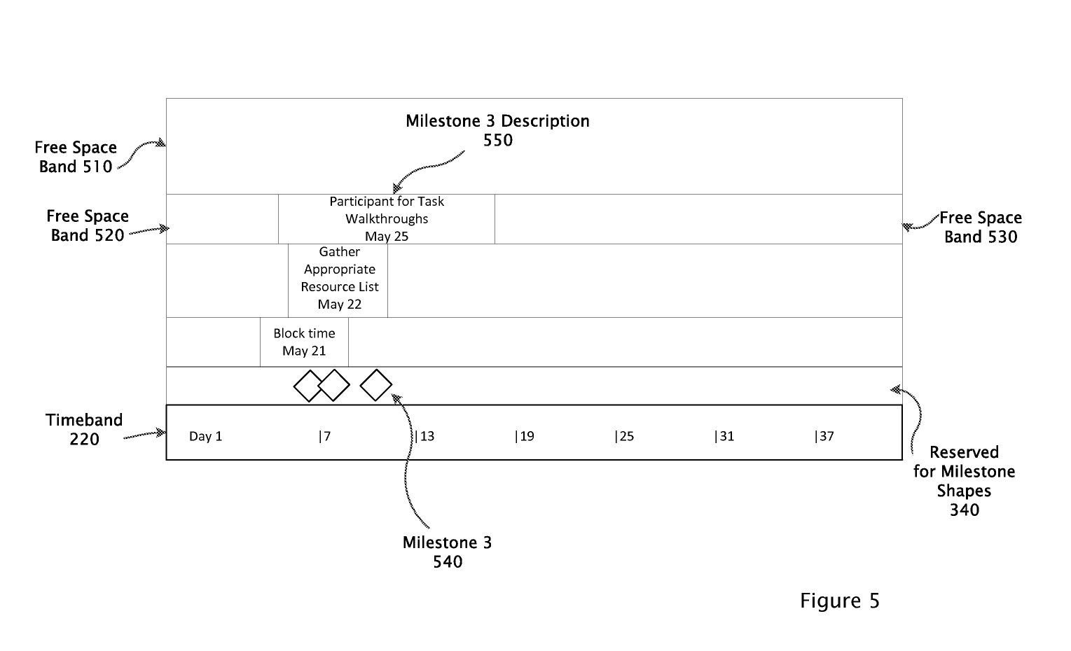

FIG. 5 illustrates an example of a Smart TimeLine with three milestones displayed, according to one embodiment. A third milestone, Milestone 3 540 has been added to the Smart Timeline shown in FIG. 4. Milestone 3 Description 550 may define a third band of space, with boxes on either side, Free Space Band 520 and Free Space Band 530. As in FIG. 4, Milestone 3 Description 550 may not fit in lower free space bands, and may trigger the creation of a new band, which may have free space including Free Space Band 520, 530.

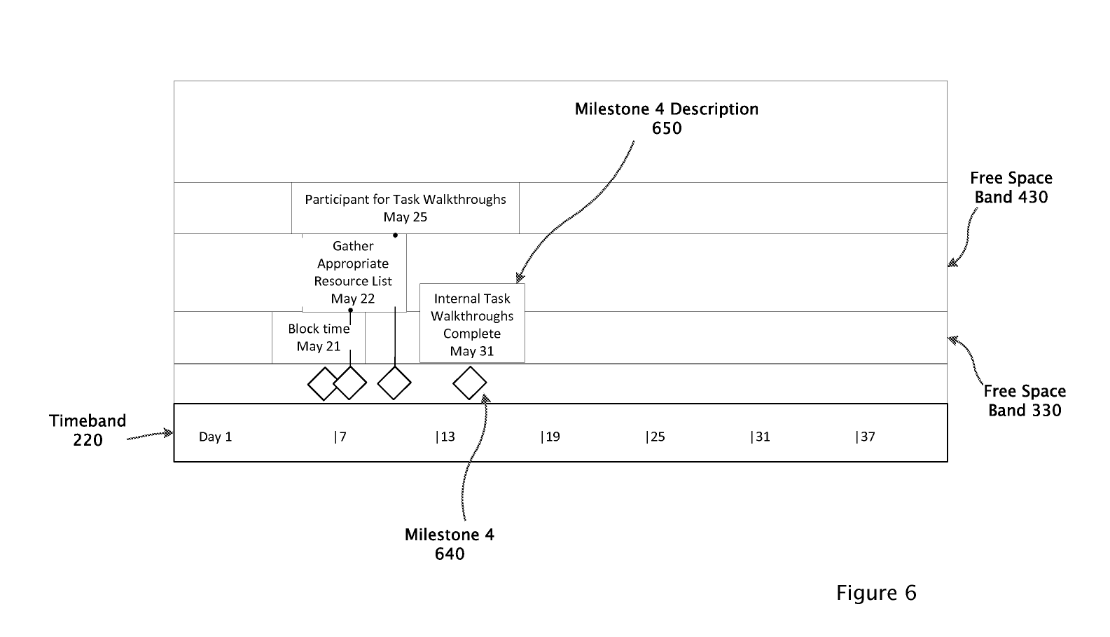

FIG. 6 illustrates an example of a Smart TimeLine with four milestones displayed, according to one embodiment. Milestone 4 640 has been added, along with Milestone 4 Description 650. In this example, there is room to place Milestone 4 Description 650 in Free Space Band 330, which allows it to be placed close to Milestone 4 640 which it may be describing. It may not fit entirely within Free Space Band 330, and may expand into Free Space Band 430.

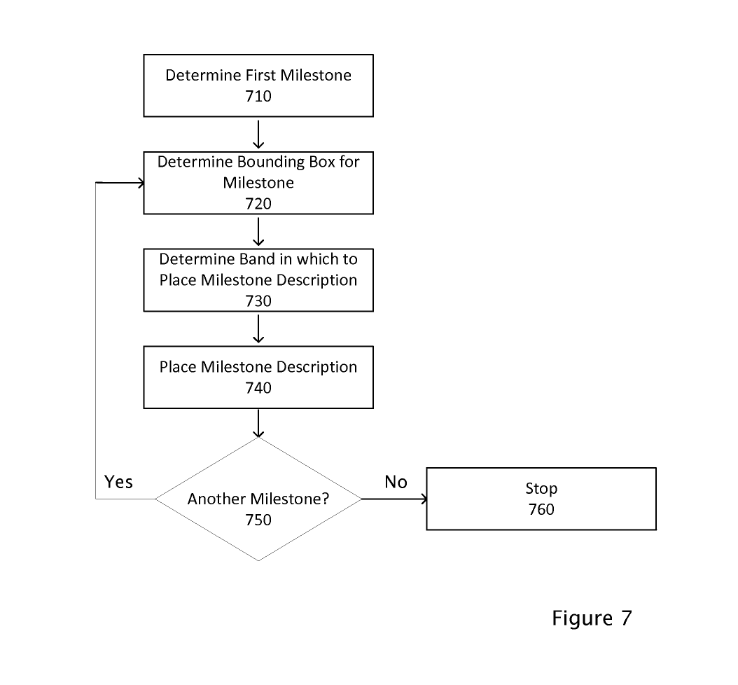

FIG. 7 is a flowchart for laying out milestone descriptions according to one embodiment. A First Milestone may be Determined 710. This may, for example, be the first milestone of a project chronologically. A Bounding Box may be Determined for Milestone 720, which may allow a band to be defined as shown in FIG. 3. An available Band may be Determined in which to Place Milestone Description 730.

A band may be determined by calculating a bounding box for the milestone description. The milestone description may be placed in the band closest to the timeline having room above the relevant milestone. If there is sufficient width in a band but insufficient height for a milestone description, two or more bands may be joined to make sufficient height for the milestone description.

The Milestone Description may be Placed in the Determined Band 740. If there is Another Milestone 750, the process may continue at step 720. If not, the process may Stop 760.

In another embodiment, milestone descriptions may be placed based upon a weighting system. The weighting system may be based upon an amount of text in the milestone description, the width of the milestone description, the height of the milestone description, or other attributes.

An example algorithm (in pseudocode) for determining placement may be as follows:

Definitions:

| Term | Definition |
|---|---|
| Timeband | A linear visual representation of a time duration for a timeline |
| Milestone | A significant event in the timeline. A milestone may have the following properties: |
| | Title |
| | Date |
| | Visually, a milestone may be represented by the following shapes: |
| | Title text box |
| | Date text box |
| | Marker shape |
| | (optional) flag pole |
| | (optional) vertical connector |
| Flag milestone | A milestone with a special shape, which may be drawn as an isosceles triangle, with the |
| | base parallel with the Y axis. |
| | A special line may be drawn parallel with the triangle base, starting from the topmost point |
| | and ending on the timeline; this line may be called a “flag pole”. |
| | Title and date text boxes may be drawn on one side of the triangle base. |
| MPBB | Milestone payload bounding box: the rectangle containing the milestone title text box and |
| | the milestone date text box. For flag milestones, the rectangle may also contain the |
| | triangle realizing the flag. |
| Milestone weight (or | The area of the milestone MPBB. |
| cost) | |
| FAAB | Free-Area Atomic Band: an area that can be used to place a MPBB; generally resulted |
| | from splitting a FAAB into smaller components. |

| | |
|---|---|
| - | Measure milestones components. Define MPBB-s. |
| - | Calculate each milestone horizontal position. |
| - | Detect milestones clusters; transform clustered milestones into a single |
| | group. |
| - | Detect unused timeline intervals; remove them from the timeband time |
| | intervals. |
| - | Update milestones horizontal positions, based on groups and removed time |
| | intervals. |
| - | Sort milestones list by their weight. |
| - | Create the initial band; the width of this band is given by the width of |
| | the rendering area; the height is the largest number supported by the |
| | machine. This band completely covers the milestones intended rendering |
| | area and it allows for overflows. Store the band in FAABDB. |
| - | For each milestone: |

```
  ∘ Detect candidate FAAB-s
  ∘ Set current band to the FAAB closest to the timeband
  ∘ [TRYFIT] If MPBB fits inside current band:
    - Set MPBB top and left coordinates
    - Split FAAB (apply rules)
    - Move to next milestone
  ∘ Else
    - If (MPBB width) < (current band width)
    ∘ [TRYJOIN] If the next available band has its bottom edge common
      with the current band top edge
        ▪Join bands, set current band to the join result
        ▪Goto [TRYFIT]
    ∘ Else
        ▪Set current band to next available FAAB
        ▪Go to [TRYFIT]
    - Else
  ∘ Set current band to next available FAAB
  ∘ Go to [TRYFIT]
```

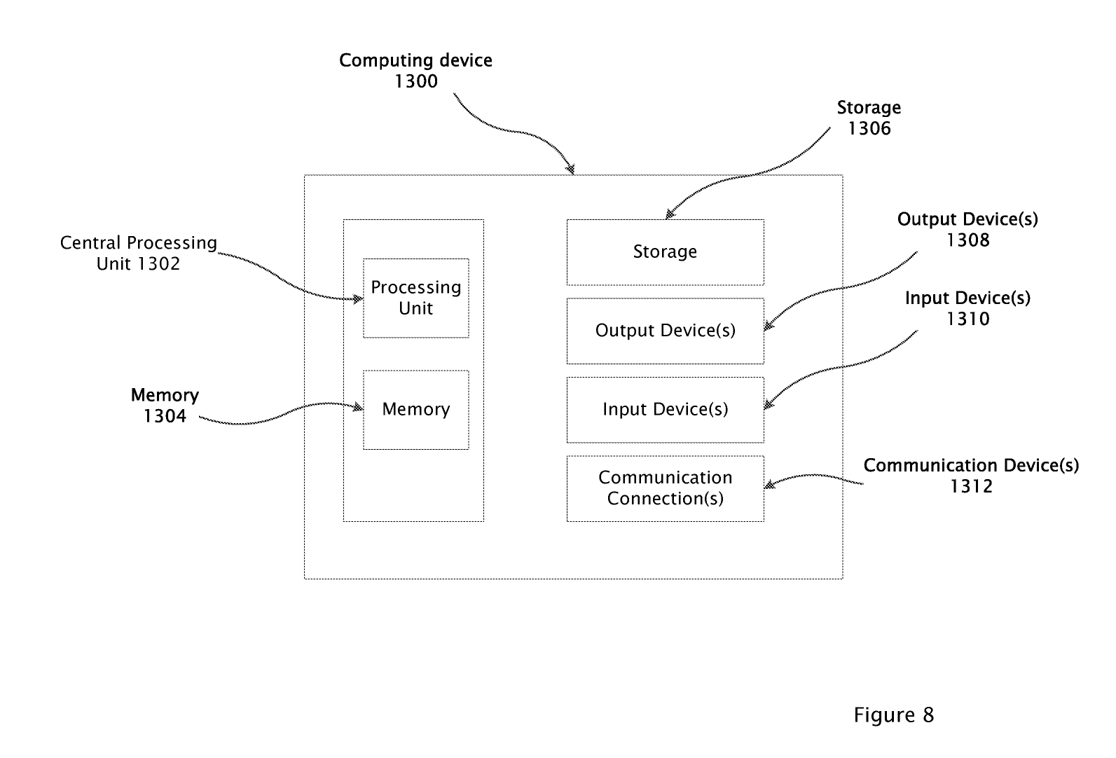

FIG. 8 illustrates a component diagram of a computing device according to one embodiment. The computing device (1300) can be utilized to implement one or more computing devices, computer processes, or software modules described herein. In one example, the computing device (1300) can be utilized to process calculations, execute instructions, receive and transmit digital signals. In another example, the computing device (1300) can be utilized to process calculations, execute instructions, receive and transmit digital signals, receive and transmit search queries, and hypertext, compile computer code as required by a User Device (110). The computing device (1300) can be any general or special purpose computer now known or to become known capable of performing the steps and/or performing the functions described herein, either in software, hardware, firmware, or a combination thereof.

In its most basic configuration, computing device (1300) typically includes at least one central processing unit (CPU) (1302) and memory (1304). Depending on the exact configuration and type of computing device, memory (1304) may be volatile (such as RAM), non-volatile (such as ROM, flash memory, etc.) or some combination of the two. Additionally, computing device (1300) may also have additional features/functionality. For example, computing device (1300) may include multiple CPU's. The described methods may be executed in any manner by any processing unit in computing device (1300). For example, the described process may be executed by both multiple CPU's in parallel.

Computing device (1300) may also include additional storage (removable and/or non-removable) including, but not limited to, magnetic or optical disks or tape. Such additional storage is illustrated in FIG. 8 by storage (1306). Computer storage media includes volatile and nonvolatile, removable and non-removable media implemented in any method or technology for storage of information such as computer readable instructions, data structures, program modules or other data. Memory (1304) and storage (1306) are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device (1300). Any such computer storage media may be part of computing device (1300).

Computing device (1300) may also contain communications device(s) (1312) that allow the device to communicate with other devices. Communications device(s) (1312) is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like. Computer readable storage media does not include transient signals.

Computing device (1300) may also have input device(s) (1310) such as keyboard, mouse, pen, voice input device, touch input device, etc. Output device(s) (1308) such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. The above specification, examples and data provide a complete description of the manufacture and use of the invention.

1. A computer-operable method for rendering a timeline, comprising:
receiving a timeband, the timeband a rendered band representing a duration of time;
creating a milestone rendering area above the timeband, the milestone rendering area is a width of the timeband, and a height less than or equal to an available height on a device rendering the timeline;
receiving a plurality of milestones, each milestone associated with a time represented on the timeband;
for each milestone:
calculating a horizontal position corresponding to a location of the associated time on the timeband;
calculating a weight;
determining a first milestone with a highest weight; and
rendering the first milestone in the milestone rendering area.
